(19) United States
(12) Patent Application Publication
(10) Pub. No.: US 2010/0045069 A1
(43) Pub. Date: Feb. 25, 2010

(54) REMOVABLE AERODYNAMIC COVER FOR PICKUP TRUCK

(76) Inventor: Igor Koba, Mountain View, CA (US)

Correspondence Address: KOBA IGOR, 845 SEVELY DR, MOUNTAIN VIEW, CA, 94041, US

(21) Appl. No.: 12/197,270

(22) Filed: Aug. 24, 2008

(51) Int. Cl. B62D 35/00; B60J 7/00

(52) U.S. Cl. 296/180.1; 296/100.06

(57) ABSTRACT

A removable aerodynamic cover for pickup truck bed is disclosed. The aerodynamic cover reduces air drag and reduces fuel consumption of a pickup truck vehicle, and increases volume of covered storage area, comparatively with commonly used flat truck bed covers. The aerodynamic cover preferably has a convex parabolic or elliptical shape and fits to the contour of the truck cabin back panel on the forward side and edge of tail gate panel on the back side. The preferred embodiment has locks or hinges for easy attaching to the side frame edges of a truck box, and optionally consists of segments for easy removing and storage.

### REFERENCES CITED

US Patent documents

| | | |
|---|---|---|
| 4,573,730 | 03/04/1986 | Gondert, et al. |
| 5,553,652 | 09/10/1996 | Rushford |
| 6,325,448 | 12/04/2001 | Estrada, et al. |
| 6,257,654 | 07/10/2001 | Boivin, et al. |
| 3,731,969 | 05/08/1973 | Bildfell |
| U.S. pat. Appl. | 02/07/2008 | Cooper; Kevin R. |
| 2008/0030049 | | |

### BACKGROUND OF THE INVENTION

1. Field of the Invention

This invention generally relates to aerodynamic drag reducing system and truck cover for vehicles.

2. Description of the Related Art

There is considerable interest in reducing fuel consumption of vehicles due to increased fuel cost and environmental pollution issues. There are many ways of reducing fuel consumption of vehicles. Reducing air drag of moving vehicle by improving shape of vehicle is one of the approaches. For pickup truck type of vehicles reducing air drag is difficult however due to complicated shape of vehicle having raise cabin in front, with vertical back side and open truck box area with vertical tailgate perpendicular to the airflow.

Even relatively small reduction in fuel consumption of vehicles (by few percents) is important for global economy and environment, and also becomes important for individual owners.

It is known that pickup truck have slightly lesser air drug resistance when tailgate is in closed (vertical) position. However air drug is still substantial due to complicated airflow and air vortices forming by air behind perpendicular back walls of cabin and tailgate.

It is known that flat truck box cover (sometimes known as tonneau cover) may reduce air drag and reduce fuel consumption. There are numerous designs of flat truck bed covers covering truck box volume fully or sometimes partially. There are claims in industry that flat truck box cover may reduce drag and reduce fuel consumption up to 5%-10%. Additional benefit of such covers is improving look of pickup vehicle and protection of cargo in the box from weather elements. Such covers disclosed in numerous publications including U.S. Pat. No. 4,573,730 “Drag reducing partial tonneau for pickup truck”, issued Mar. 4, 1986, U.S. Pat. No. 5,553,652, etc. U.S. Pat. No 6,325,448 “Enhanced aerodynamic device for trucks” discloses device substantially storage box attached to the rear tailgate of track vehicle.

Also known in industry attempts to reduce aerodynamic drag by air deflector surfaces behind the roof of vehicle cabin. This been shown to reduce air drag by up to 1% according to some publications. Such air deflectors disclosed for example in U.S. Pat. No. 4,159,843, U.S. Pat. No. 6,257,654 “Air drag reducing apparatus”, U.S. Pat. No. 3,731,969 “Aerodynamic deflector”.

Combinations of the partial horizontal cover of truck box and air deflector on the roof of vehicle disclosed in recent U.S. pat. Application 2008/0030049 “Aerodynamic drag reducing system for pickup truck”.

While many designs and patents exist for typically flat truck bed covers, they do not approach advantages aerodynamically perfect shape known to minimize air drag or vehicles. Even with horizontal bed cover or air deflectors moving pickup truck vehicle subject to substantial aerodynamic drag generated by imperfect airflow and air vortices forming in air behind moving vehicle. Conventional flat truck box cover also limits useful storage area in the truck box, which for some owners contradicts with the primary purpose of pickup vehicle.

Present invention takes a concept of aerodynamic truck cover further to the next step by giving nearly perfect teardrop aerodynamic shape to a pickup truck vehicle.

### SUMMARY OF THE INVENTION

The removable aerodynamic truck cover is disclosed in present invention. The aerodynamic truck cover preferably has a convex parabolic or elliptical shape and fits to the contour of the truck cabin back panel on the forward side and edge of tail gate panel on the back side. Thus it approximates “perfect” aerodynamic shape that minimizes air resistance. Such shape typically used for cars and passenger vehicles.

Using such shape for truck cover substantially reduces aerodynamic drag resistance and improves fuel economy, especially at high speed when air resistance contributes substantially in vehicle fuel consumption. The advantage in air drag comes due to improved pattern of airflow and elimination of complex vortices forming in air behind truck cabin.

It is additional benefit of the disclosed invention that concave shape of truck cover increases protected storage volume inside truck box, comparatively to conventional flat truck cover.

It is author's estimation that using such shape for truck cover should reduce air drag and improve fuel consumption by at least 10%-15%, i.e. at least 5% better that using conventional flat truck bed covers.

In one embodiment the invention comprises a fixed frame rails or fixed latches attached to the upper edges of pickup truck box and behind cabin. Said rails or latches attached permanently one time to the body of vehicle and form a device for easy removable attachment of said convex aerodynamic truck cover to the vehicle.

In one embodiment the convex aerodynamic truck cover is attached to the vehicle by easily locking and unlocking latches on the sides of truck box and behind cabin. The cover is easily removable for using or storage.

In yet another embodiment the convex aerodynamic truck cover is attached to the vehicle by latches on one side and by rotating hinges on other side thus allowing easy access to the truck box inside volume for loading and unloading.

In yet another embodiment the convex aerodynamic truck cover is attached to the vehicle by latches and consists of multiple elongates segments connected by flexible attachment along connection lines, wherein connection lines parallel or perpendicular to the axis of the vehicle. In that embodiment convex shape of segments adds benefit of improving rigidness, comparatively to the common flat covers.

### BRIEF DESCRIPTION OF THE DRAWINGS

FIG. 1. is a perspective view of Aerodynamic cover fitted to the pickup track.

FIG. 2. is a perspective view of one embodiment of invention Aerodynamic cover fitted to the pickup track where fixed rails or frame is permanently attached to body of the vehicle, said frame provides base for easy removable attachment of said Aerodynamic cover.

FIG. 3. is a perspective view of second embodiment of invention wherein said Aerodynamic cover is attached to the body of vehicle by means of hinges on one side and lock on another side of vehicle, where said Aerodynamic cover opens to one side of vehicle.

### DETAILED DESCRIPTION OF THE INVENTION

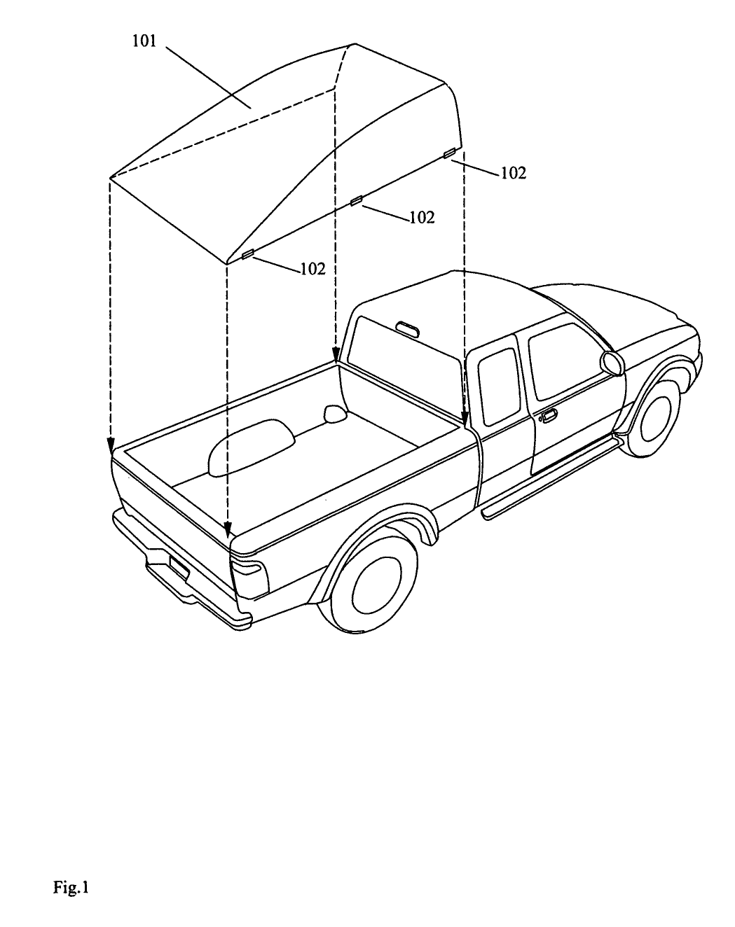

With reference to the drawings in which like numerals indicate like elements throughout, FIG. 1 illustrates perspective view of Aerodynamic cover 101 fitted to the pickup track. Preferably said Aerodynamic cover 101 has a convex parabolic or elliptical shape and fits to the contour of the truck cabin back panel on the forward side and edge of tail gate panel on the back side. Preferably said Aerodynamic cover attaches to the body of a pickup vehicle by means of detachable locks or hinges 102 disposed on the edges of said Aerodynamic cover. Preferably said Aerodynamic cover has rubber or flexible plastic seal (not shown on the illustration) around the edges for airtight seal between said Aerodynamic cover and body of a vehicle.

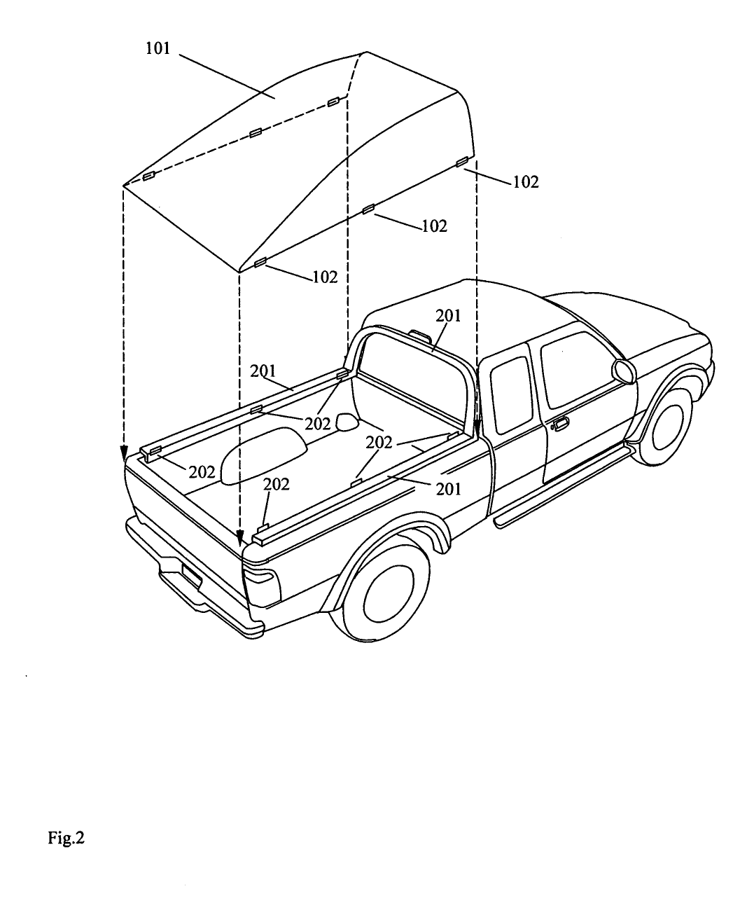

In one embodiment shown on FIG. 2. said Aerodynamic cover attaches to the body of a pickup vehicle by utilizing fixed frame or rails 201, preferably made of plastic or aluminum, where said frame or rails permanently attached to the boy of vehicle, preferably located on the upper edges of truck box and on the rear side of vehicle cabin. Said fixed frame or rails provide fixed base for easy attaching removable Aerodynamic cover 101 to the vehicle. Preferably said fixed frame or rails have latches 202 disposed such that they mating with latches or hinges 102 on the edge of said Aerodynamic cover, providing means for rigid attaching and easy removing of said Aerodynamic cover.

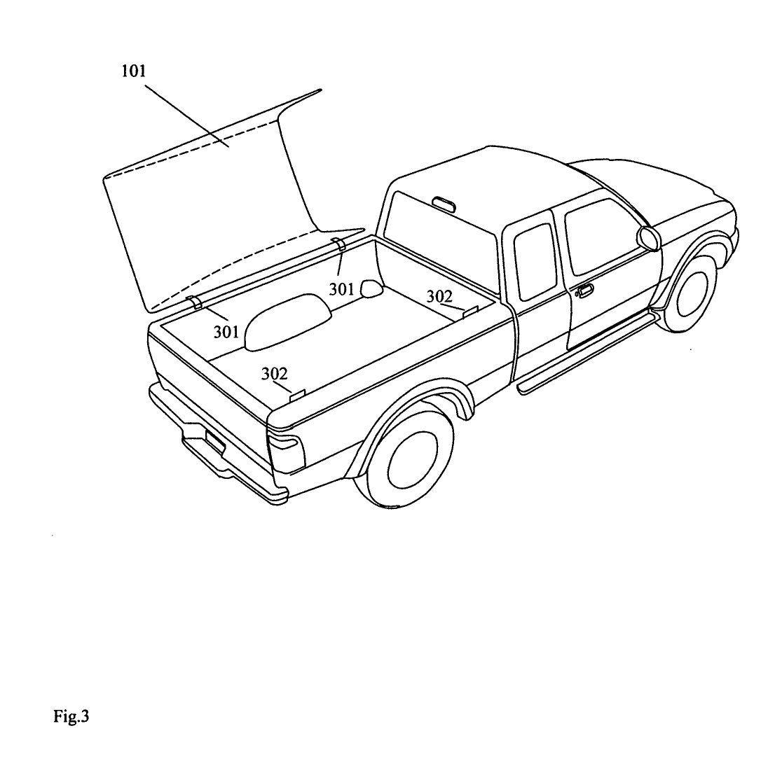

FIG. 3. illustrates yet another embodiment of present invention, where said Aerodynamic cover attaches to the body of a pickup vehicle by hinges 301 on one side of vehicle and locks 302 on the other side. In this embodiment said Aerodynamic cover 101 opens to one side of vehicle for loading and unloading. Preferably said Aerodynamic cover attached to hinges 301 by means of detachable lock (not shown on illustration) for ease of complete removing of said Aerodynamic cover.

In yet another embodiment of present invention, similar to shown on FIG. 3. preferably both elements 302 and 301 comprise hinges and locks thus allowing opening said Aerodynamic cover to both sides of vehicle for easy loading and unloading.

Aerodynamic cover according to present invention provides shape of vehicle approximating teardrop shape which minimizes air drug of moving object as is known in the art and is used for other types of vehicles. The exact shape of said Aerodynamic cover for minimizing air drug resistance to be determined in future research by means such as Computation Fluid Dynamic (CFD) calculations and/or testing in wind tunnel.

The embodiments and examples set forth herein are presented to best explain the present invention and its practical application and to thereby enable those skilled in the art to make and utilize the invention. Those skilled in the art, however, will recognize that the description and examples are presented for the purpose of illustration and example only. Other variations and modifications of the present invention will be apparent to those of skill in the art, and it is the intent of the appended claims that such variations and modifications be covered. Furthermore, although elements of the invention may be described or claimed in the singular, the plural is contemplated unless it is expressly stated to the contrary.

What is claimed is:

1. A removable aerodynamic drag reducing system for pickup truck comprising aerodynamic truck cover wherein said cover fits to the contour of the truck cabin back panel on the forward side and edge of tailgate panel on the back side.

2. A removable aerodynamic drag reducing system of claim 1, wherein said aerodynamic truck cover has convex parabolic shape.

3. A removable aerodynamic drag reducing system of claim 1, wherein said aerodynamic truck cover has convex elliptical shape.

4. A removable aerodynamic drag reducing system of claim 1, wherein said aerodynamic truck cover has locks disposed along the edges on each side for easy removable attachment to the vehicle, and a vehicle has mating locks (latches) disposed along the upper edge of the track box and cabin for attachment with said removable aerodynamic truck cover.

5. A removable aerodynamic drag reducing system of claim 1, wherein said aerodynamic truck cover has flexible rubber seal along the edges coming in contact with track body and back of cabin for airtight and watertight attachment to vehicle.

6. A removable aerodynamic drag reducing system of claim 1, wherein said aerodynamic truck cover attaches to the vehicle with the help of fixed frame where said frame permanently attached to the sides of track box and back panel of cabin and wherein said frame has mating latches for locking with corresponding locks on the edges of said removable aerodynamic truck cover.

7. A removable aerodynamic drag reducing system of claim 1, wherein said aerodynamic truck cover attaches to the vehicle with the help rotating hinges on one of side of vehicle, disposed along upper edge of truck bed, and locks on the other side of vehicle for easy access to cargo by opening said cover by rotating to one side.

8. A removable aerodynamic drag reducing system of claim 1, wherein said aerodynamic truck cover attaches to the vehicle with the help rotating hinges with detachable locks on both sides of vehicle, disposed along upper edge of truck bed, for easy access to cargo by opening said cover by rotating to either one or another side of vehicle, and for easy removing said aerodynamic truck cover.
